(19) United States
(12) Patent Application Publication
(10) Pub. No.: US 2002/0120733 A1
(43) Pub. Date: Aug. 29, 2002

(54) Method, program and arrangement for synchronizing a network manager to a network agent

(76) Inventor: Gerhard Kring, Muenchen (DE)

Correspondence Address: BELL, BOYD & LLOYD, LLC, P. O. BOX 1135, CHICAGO, IL, 60690-1135, US

(21) Appl. No.: 10/057,019

(22) Filed: Jan. 25, 2002

(30) Foreign Application Priority Data
Jan. 26, 2001 (EP) 01101819.9

(51) Int. Cl. G06F 15/16; G06F 15/173

(52) U.S. Cl. 709/223; 709/202

(57) ABSTRACT

A method, program and system for synchronizing a network manager to a network agent, wherein, in a communications network in which managers maintain data unit copies of data units of their agents, a unique first value, a second value for indicating the number of changes to the associated data unit and a third value for indicating who initiated the respective last change are stored for each data unit in the agent. A copy of the associated three values is stored for each data copy in the manager, and the copies are compared with the respectively associated three values which are stored in the agent. Each data copy whose copies of the three values which are stored in the manager do not match the associated three values which are stored in the agent A is synchronized to the associated data unit which is stored in the agent.

### BACKGROUND OF THE INVENTION

The management of communications networks which include a number of switching nodes is normally carried out via a manager/agent architecture. In an architecture such as this, the switching nodes normally represent the agents, and the management nodes for management of the communications network represent the managers. Furthermore, umbrella management nodes may be provided, for management of the managers, in complex communications networks. In a scenario such as this, the management nodes have two roles: firstly, they act as managers for the switching nodes; secondly, they are the agents of the umbrella management nodes. The umbrella management nodes are themselves, in turn, the managers of the management nodes.

Normally, each agent maintains a local database. In an object-oriented management architecture, this is also referred to as a Management Information Base (MIB). In this case, so-called object instances are stored in an MIB. Object instances generally include a large number of so-called attributes, in which different information is stored. For performance reasons, the managers also maintain a local database in which at least parts of the MIB are stored in copy form by each of the agents associated with the manager. In this case, each copy in the managers is regarded as being potentially incorrect, since it need not necessarily be identical to the respective MIB in the agent. The MIB in the agent is, thus, regarded as the master; that is to say, its object instances contain the correct values, which are binding on agents and managers.

An agent/manager pair is synchronized as long as the copy of the agent MIB stored in the manager is identical to the MIB stored in the agent. However, a number of events may occur which could result in a manager losing its synchronicity with one or more of its agents, or which would at least lead to the manager no longer knowing whether or not it is synchronized. For example, it would be possible for the manager to fail for a time, and for changes which were carried out to an MIB in an agent during this time not to be included there. Alternatively, the connection between the manager and agent could be interrupted, with the manager not knowing, after the end of the interruption, whether its copy is still up-to-date. In both cases, the manager will check and, if necessary, update its copy. With a small MIB, this may be done by the manager reading the entire MIB from the agent. However, if the MIB in the agent is very large, time-optimized methods are normally used for resynchronization.

Owing to the major importance of network management for operation of communications networks, additional accompanying measures are frequently taken in order to minimize the effects of failures of nodes or connections on the operation of the communications networks:

Each local database can be protected by a backup/restore system. In this case, a backup of the protected database is produced at regular intervals and is accessed in the event of loss of the database, for example, due to a hard-disk crash. This is carried out, in particular, for the master database in the respective agents.

Each manager has at least one associated backup manager which, in the event of failure of the (primary) manager or of the connections, acts as a substitute manager until the primary manager resumes the management task. European Patent Application EP 0 898 398 discloses a method for time-optimized resynchronization of a manager to its agents. In this case, UNIQUEID and DATASYNCH attributes are provided in each object instance. UNIQUEID is a unique number which is allocated to each object instance when it is produced. The value range of UNIQUEID is chosen such that, in practice, more unique IDs than object instances are always available in each agent. DATASYNCH is a number which is allocated to each object instance when it is produced, and is initially given the value 0 or 1. Whenever the object instance is modified, DATASYNCH is increased by 1. The value range of DATASYNCH is thus chosen such that it is possible to deal with any number of modifications which may be expected in practice and which occur during an asynchronicity phase between a manager and agent.

For synchronization to an agent, the manager for all the object instances which are copied into the local database of that manager checks their UNIQUEID and DATASYNCH from the MIB for the agent, and compares these values with those of the copies in the local database of that manager. Every local copy of an object instance is deleted whose local DATASYNCH differs from the checked DATASYNCH. These object instances are then completely reloaded by the agent into the local database of that manager.

However, this method cannot be used for agents whose local database is protected by a backup/restore system, as the following example, which is also illustrated in FIG. 1, shows:

1. Initial situation: DATASYNCH for the object D has the value x.

2. Agent A carries out a backup.

3. Manager M1 changes the object D to state Z1. In the process, DATASYNCH for the object D in the agent A and in the manager M1 is increased to x+1.

4. Manager M1 or its connection to the agent A fails.

5. Agent A (and/or the manager M2) takes over control.

6. A fault occurs in the agent A, which makes it necessary to restore the object D from the backup.

7. DATASYNCH for the object D_{A} in the agent A once again has the value x.

8. Agent A (or the manager M2) changes the object D to a state Z2 (not the same as Z1). DATASYNCH for the object D is increased in the agent A (and, possibly, in the manager M2) to x+1.

9. The manager M1 takes over control once again.

10. The comparison of the version counter DATASYNCH shows synchronicity for the object D, even though the object D in the manager M1 is in the state Z1, and that in the agent A is in the state Z2.

An object of the present invention is, thus, to find an improved method for synchronizing a network manager to a network agent.

A further object of the present invention is to find a method for synchronizing a network manager to a network agent, which leads to correct synchronization even when using a backup-restore system for protection of a local database for the network agent.

### SUMMARY OF THE INVENTION

Correct synchronization of a network manager to a network agent whose local database is protected by a backup-restore system is advantageously achieved in this way. The value MANAGERID which is an additional feature in comparison with the European Patent Application EP 0 898 398, avoids the incorrect synchronization as in the above example. Admittedly, DATASYNCH for the object D has the value x+1 both in the manager M1 and in the agent A. However, after carrying out step 8, MANAGERID for the object D in the manager M1 has the value “M1,” and has either the value “A” or “M2” in the agent A. Thus, when the copies of the three values UNIQUEID, DATASYNCH, MANAGERID for the object D which are stored in the manager M1 are compared with the associated three values UNIQUEID, DATASYNCH, MANAGERID for the object D which are stored in the agent A, the two MANAGERIDs do not match one another. In consequence, the object D for the manager M1 is now synchronized to the associated object D stored in the agent.

The method for synchronizing a network manager to a network agent is, thus, advantageously improved overall, since it now can be used when the local database of an agent is protected by a backup/restore system.

As already explained, the method according to the present invention furthermore and advantageously also leads to correct synchronization when the (primary) manager M1 also has at least one (backup) manager M2 associated with it, in addition to a backup/restore system.

Additional features and advantages of the present invention are described in, and will be apparent from, the following Detailed Description of the Invention and the Figures.

### BRIEF DESCRIPTION OF THE FIGURES

FIG. 1 shows a system for carrying out the method according to the present invention, having two managers, one agent and a backup system associated with the agent, as well as programs for carrying out the method according to the present invention.

FIG. 2 shows a flowchart illustrating, schematically, the sequence of the method according to the present invention.

### DETAILED DESCRIPTION OF THE INVENTION

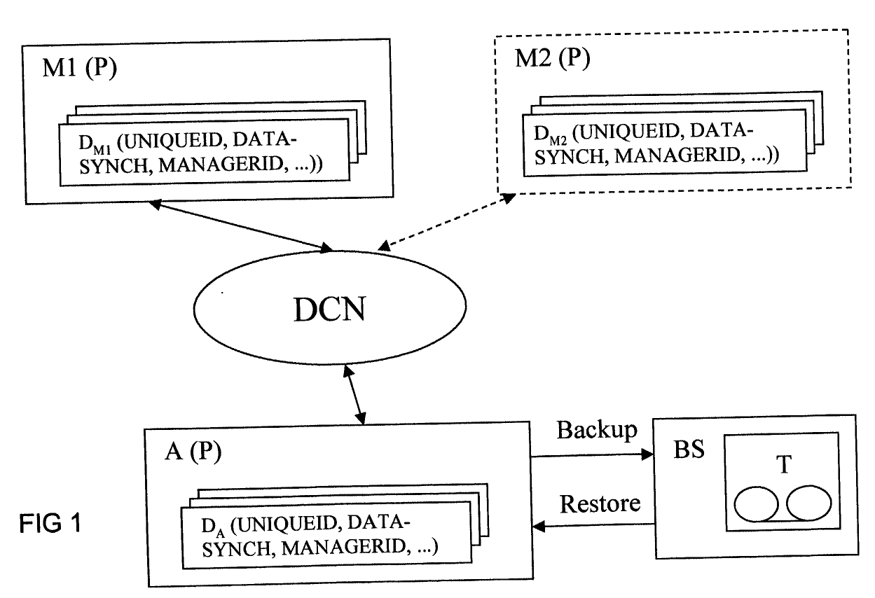

FIG. 1 shows an example of a system for carrying out the method according to the present invention, which has a first (primary) manager M1 and an optional second (backup) manager M2 (indicated by dashed lines in FIG. 1), an agent A and a backup system BS associated with the agent A. The manager M and the agent A are connected to one another via a data communications network DCN. The backup system BS is associated with the agent A and includes, for example, a tape T for storing backups of the local database for the agent A. Programs P for carrying out the method according to the present invention are provided in the managers M1 and M2, and in the agent A. At least one data unit D_{A} is provided in the agent A, and has an associated data unit copy D_{M1} in the manager M1 and an associated data unit copy D_{M2} in the manager M2. The data unit D_{A} and the data unit copies D_{M1}, D_{M2} are, for example, in the form of object instances.

The three object instances D_{M1}, D_{M2}, D_{A} each represent the same data unit D, which is also referred to as the object, in this object-oriented embodiment. The object instance D_{A} is, in this case, assumed to be the master, whose values are always regarded as being correct, while the values in the copied object instances D_{M1}, D_{M2} possibly may be incorrect and, in this case, need to be synchronized to the values of the object instance D_{A}. Each of the three object instances D_{M1}, D_{M2}, D_{A} for this purpose has at least one first value UNIQUEID for unique identification of the mutual association between the three object instances D_{M1}, D_{M2}, D_{A}, a second value DATASYNCH for indicating the number of changes to the data unit D, and a third value MANAGERID for indicating who initiated the respective last change to the data unit D. At least one further value of the object instance D_{A} is normally provided as a copy in the copied object instances D_{M1}, D_{M2}.

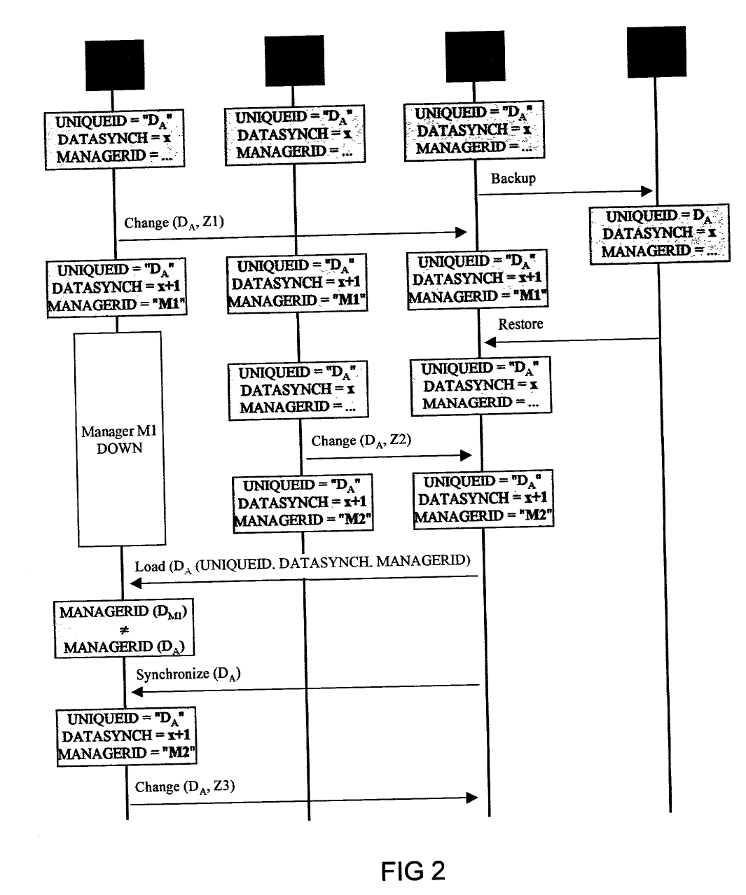

FIG. 2 shows an example of the sequence for the method according to the present invention, schematically. This relates to synchronization between the object instance D_{A} in the agent A and its associated object instances D_{M1}, D_{M2} in the managers M1, M2. The value UNIQUEID is, in this case, formed, for example, as a string “D_{A}” in each of the three object instances D_{M1}, D_{M2}, D_{A}. The values DATASYNCH and MANAGERID are allocated, according to the present invention, as follows:

1. Initial situation: DATASYNCH is assumed to be allocated a number x while MANAGERID is assumed to be allocated any desired string, in all three object instances D_{M1}, D_{M2}, D_{A}.

2. The agent A carries out a backup. In consequence, the object instance D_{A} is stored in the backup system BS with the above values.

3. The manager M1 initiates a change to the state Z1 for the object D. This is indicated to the agent A by a change message (DA, Z1). At the same time, DATASYNCH is increased to x+1 and MANAGERID is set to “M1” in the agent A and in the manager M1 (and, possibly, in the manager M2).

4. The manager M1 (or its connection to the agent A) fails. Alternatively, the database of the manager M1 could fail, and be replaced by an older backup version of this manager database.

5. The agent A (and/or the manager M2) takes over control of the object D.

6. A fault occurs in the agent A, which makes it necessary to restore the object D_{A} from the backup system BS.

7. As a consequence of the backup, DATASYNCH for the object instance D_{A} in the agent A (and possibly the object instance D_{M2} in the manager M2) is once again set to x, and MANAGERID is once again set to any desired string.

8. The agent A (or the manager M2) initiates a change to state Z2 (not the same as Z1) of the object D. On initiation by the manager M2, this is indicated to the agent A by a change message (D_{A}, Z2). At the same time, DATASYNCH is increased to x+1 and MANAGERID is set to “A” (or possibly “M2”) in the agent A (and, possibly, in the manager M2).

9. The failure of the manager M1 (or of its connection to the agent A) is ended. The manager M1 takes over control of the object D once again.

10. The manager M1 checks and, if necessary, reproduces its synchronicity with the agent A. This is done by transmitting the values UNIQUEID, DATASYNCH and MANAGERID for the object instance D_{A} to the manager M1 using the load message (D_{A}).

A comparison of the transmitted version counter DATASYNCH with the copy of the value DATASYNCH which is stored in the manager M1 would admittedly indicate synchronicity for the object D, even though the object D has the state Z1 in the manager M1, and the state Z2 in the agent A, since both have been allocated x+1.

However, the transmitted MANAGERID (D_{A}) according to the present invention is allocated “A” (or “M2”), while the copy of the MANAGERID (D_{M1}) which is stored in the manager M1 is still assigned the string “M1”. The comparison of MANAGERID (D_{A}) with MANAGERID (D_{M1}) according to the present invention thus indicates an inequality; that is to say, lack of synchronicity.

In consequence, the object instance D_{M1} in the manager M1 is now synchronized to the object instance D_{A} for the agent A. This is done by loading the necessary further values of the object instance D_{A} from the manager M1 with the aid of the synchronize message (D_{A}). In this case, DATASYNCH is also set to x+1 and MANAGER (D_{M1}) is set to “M2” in the object instance D_{M1}.

Particularly major advantages result if the comparison of the copies of the values UNIQUEID, DATASYNCH, MANAGERID which are stored in the manager M1 for the object instance D_{M} with the associated values UNIQUEID, DATASYNCH, MANAGERID which are stored in the agent A is carried out only, or for the first time, on access to the object instance D_{M} which is stored in the manager M1. This advantageously results in object instances D_{M} which are stored in the manager M and which are accessed only rarely are synchronized only when necessary.

According to one preferred embodiment of the present invention, this comparison is carried out whenever the object instance D_{M} which is stored in the manager M1 is accessed. Alternatively, the comparison may be carried out only once, on the respective first access after a failure of the manager M1 or of its connection to the agent A, thus further reducing the synchronization effort.

In a further exemplary embodiment, the comparison of the copies of the values UNIQUEID, DATASYNCH, MANAGERID which are stored in the manager M1 with the respectively associated values UNIQUEID, DATASYNCH, MANAGERID which are stored in the agent A is carried out for all the object instances D_{M} which are stored in the manager M. Such full synchronization of the database of the manager M1 to its agent A could be carried out, for example, fully automatically after any failure of the manager M1 or its connection to the agent A. Alternatively, a manual start is provided for synchronization; in particular, for full synchronization.

Finally, it shall be stressed that the description of those components of the communications network KN which are relevant to the present invention should not, in principle, be regarded as being restricting. In particular, it is obvious to a person skilled in the relevant art that terms such as “manager” or “agent” should be regarded functionally rather than physically. The managers M1, M2 and the agent A also may, for example, be provided partially or entirely in software, and/or distributed between a number of physical devices.

Although the present invention has been described with reference to specific embodiments, those of skill in the art will recognize that changes may be made thereto without departing from the spirit and scope of the invention as set forth in the hereafter appended claims.

1. A method for synchronizing a network manager to a network agent in a communications network, in which managers maintain data unit copies of data units of their respective agents, the method comprising the steps of:
storing a first value, which is unique for each data unit, in the agent;
storing a second value, for indicating a number of changes to the associated data unit, in the agent;
storing a third value, for indicating who initiated a respective last change, in the agent;
storing a copy of each of the first, second and third values for each data copy in the manager;
comparing the copy of the first, second and third values stored in the manager with the respectively associated first, second and third values stored in the agent; and
synchronizing each data copy, whose copies of the first, second and third values stored in the manager do not match the associated first, second and third values stored in the agent, to the associated data unit stored in the agent.

2. A method for synchronizing a network manager to a network agent in a communications network as claimed in claim 1, wherein the step of comparing is carried out during access to the data copy which is stored in the manager.

3. A method for synchronizing a network manager to a network agent in a communications network as claimed in claim 2, wherein the step of comparing is carried out whenever access is made to one of the data unit copies which are stored in the manager.

4. A method for synchronizing a network manager to a network agent in a communications network as claimed in claim 2, wherein the step of comparing is carried out only once when access is, in each case, made for a first time to one of the data unit copies which are stored in the manager, after one of a failure of the manager and connection of the manager to the agent.

5. A method for synchronizing a network manager to a network agent as claimed in claim 1, wherein the step of comparing is carried out for all the data copies which are stored in the manager

6. A program having a plurality of software code sections, wherein execution of the software code sections effects a method comprising the steps of:
storing a first value, which is unique for each data unit, in the agent;
storing a second value, for indicating a number of changes to the associated data unit, in the agent;
storing a third value, for indicating who initiated a respective last change, in the agent;
storing a copy of each of the first, second and third values for each data copy in the manager;
comparing the copies of the first, second and third values stored in the manager with the respectively associated first, second and third values stored in the agent; and
synchronizing each data copy whose copies of the first, second and third values stored in the manager do not match the associated first, second and third values stored in the agent, to the associated data unit stored in the agent.

7. A system for synchronizing a network manager to a network agent in a communications network, in which managers maintain data unit copies of data units of their respective agents, the system comprising:
a communications network;
a network agent connected to the communications network, the network agent storing a first value which is unique for each data unit, a second value for indicating a number of changes to the associated data unit, and a third value for indicating who initiated a respective last change; and
a network manager connected to the communications network, the network manager storing a copy of each of the first, second and third values for each data copy, wherein the copies of the first, second and third values stored in the manager are compared with the respectively associated first, second and third values stored in the network agent, and each data copy whose copies of the first, second and third values stored in the manager do not match the associated first, second and third values stored in the agent is synchronized to the associated data units stored in the agent.
